(19) United States
(12) Patent Application Publication
(10) Pub. No.: US 2007/0190654 A1
(43) Pub. Date: Aug. 16, 2007

(54) Process for qualitative and/or quantitative determination of at least one molecule present on a solid surface

(75) Inventors: Sandra Sisalli, Grasse (FR); Patrick Sandra, Kortrijk-Marke (BE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignees: Chanel Parfums Beaute, Neuilly-Sur-Seine (FR); Research Institute for Chromatography, Kortrijk (BE)

(21) Appl. No.: 11/598,676

(22) Filed: Nov. 14, 2006

Related U.S. Application Data
(60) Provisional application No. 60/748,207, filed on Dec. 8, 2005.

(30) Foreign Application Priority Data
Nov. 14, 2005 (FR) 0511517

(51) Int. Cl. C01B 31/08

(52) U.S. Cl. 436/8; 502/416

(57) ABSTRACT

The invention concerns a method for qualitative and/or quantitative determination of at least one molecule present on a solid surface, in which a polysiloxane-based sorbent material is used.

This application claims priority under 35 U.S.C. 119(e) to provisional application 60/748,207, filed on Dec. 8, 2005 and under 35 U.S.C. 119(a)-(d) to French application No. 0511517, the disclosures of which are herein incorporated by reference.

### FIELD OF INVENTION

The invention concerns a method for qualitative and/or quantitative determination of at least one molecule of interest present on a solid surface.

### BACKGROUND OF THE INVENTION

This type of determination is required in a great many technical fields, in which it is required to be able to determine and to analyze easily the presence and/or the quantity of such molecules, particularly in relation to one or more factors intrinsic or extrinsic to said surface liable to influence its existence.

There may be cited, for example, the field of agriculture, for evaluating the presence or the quantity of contaminants on the surface of plants or elements of the soil; the industrial field, for determining the possible presence of contaminants on electronic components or devices; the field of the environment, for determining the possible presence of contaminants on domestic surfaces (wall or floor coverings); the biomedical or cosmetics field, for evaluating or characterizing the presence of a perfume, the activity of a medication or a drug on the skin or another biological surface.

However, this type of determination on a solid surface may be rendered difficult by the nature of the surface: in fact, optimum contact is required between the surface to be analyzed and the material used for the analysis in order, on the one hand, to avoid any possible contamination by elements not involved in the required determination and, on the other hand, to enable good exchange between the surface studied and the material used for the analysis, so as to optimize the extraction of the molecule of interest.

In the fields of pharmaceuticals and cosmetics, and more generally in the field of biology, it is required to obtain qualitative and quantitative information on biological or synthetic molecules present on a biological surface, and particularly the skin, and representative of the interactions of the latter, and its environment.

In particular, it is required to study the activity of existing agents or to evaluate the reaction of a biological surface to environmental factors and to be able to analyze the chemical composition of a biological surface in vivo in an ambulatory and noninvasive manner.

Different techniques have been used until now for the direct analysis of the skin in vivo.

There may be mentioned, for example, imaging techniques such as high-resolution ultrasound scanning (sonography), magnetic resonance imaging and laser scanning confocal spectroscopy. These techniques are used to obtain information on the thickness of the skin, to visualize the constituents of the skin (cells, extracellular fluids), or to differentiate the constituents of the skin according to their chemical nature (water, proteins, lipids, etc.).

There may also be mentioned spectroscopic techniques such as infrared spectroscopy, Raman confocal spectroscopy and nuclear magnetic resonance spectroscopy. These techniques enable information to be obtained on the constitution of the skin.

However, all these techniques have the drawback of not being usable in an ambulatory context and of not being specifically adapted to measurements on the surface of the skin.

Moreover, techniques for sampling of the skin in vivo have also been developed. For example, strips of rigid materials consisting of a glass-based substrate covered with cyanoacrylate resins or adhesive strips based on hydrophobic polymer substrates covered with an adhesive layer, such as those described in U.S. Pat. No. 5,088,502, have been used in “stripping” methods (application of the material to the skin under constant pressure, followed by removal).

These methods are used to obtain samples of scales, which may be directly analyzed by imaging techniques, for example.

However, if it were required to carry out a chemical analysis by chromatography, a step of desorption of the sample from the strip would prove necessary. This step is generally effected by liquid extraction, which frequently gives rise to analysis artifacts caused by the nature of the adhesive. On the other hand, thermal desorption cannot be used because it degrades the strip itself.

There also exist techniques based on adsorption, i.e. in which the molecules are retained on a surface based on a material containing a fixed number of adsorption sites.

There may be cited in particular strips intended for the determination of sebum or the administration of antisebum medications on the skin, such as those described in U.S. Pat. Nos. 4,532,937 and 5,119,828, consisting of a porous hydrophobic polymer substrate covered with an adhesive layer, in which the sebum molecules or the molecules to be administered are retained in the pores of the substrate.

These strips are generally subjected to techniques of analysis by imaging. However, they usually also include adhesive layers and their decomposition at high temperature gives rise to artifacts that may impede the analysis.

A sebum measuring device consisting of a rigid transparent substrate covered with an opaque layer for adsorbing sebum is described in U.S. Pat. No. 5,935,521. The adsorption of sebum in the opaque layer causes transparency of the latter and this transparency is measured by photometry to determine the quantity of sebum. However, this is an overall measurement (determination of the total amount of sebum) and cannot provide qualitative or quantitative data.

Moreover, these adsorption methods are not particularly reproducible: in fact, many parameters can cause the results to vary, for example saturation of the adsorption sites by molecules other than the molecules of interest.

The sampling of volatile molecules above the skin (and not on its surface) using a silica fiber coated with polydimethylsiloxane (absorption), divinylbenzene (adsorption) and carboxene (adsorption) has been reported in Ostrovskaya A. et al., Journal of Cosmetic Science, 2002, 53(2), 147-148.

However, the small quantity of material on the fiber and its use without contact with the skin considerably limit the sensitivity of this method.

There therefore exists a need to provide a reproducible method that is easy to use, can be used in an ambulatory and noninvasive context, and is adapted to sampling on any type of solid surface, to enable qualitative and/or quantitative determination of at least one molecule of interest present on that surface.

Among other things, a method of this kind is of particular benefit for in vivo sampling on a solid biological surface that necessitates the use of a material susceptible to be able to adapt optimally to this kind of surface, in particular when it is skin.

### SUMMARY OF THE INVENTION

It has now been found that using a polysiloxane based sorbent material into which said molecule of interest diffuses should enable the objectives referred to above to be achieved.

### BRIEF DESCRIPTION OF THE DRAWINGS

FIG. 1 depicts a GC/MS chromatogram of Example 1.

FIG. 2 depicts a GC/MS chromatogram of Example 2.

FIG. 3 depicts a plot of the amount of squalene produced v. time to show the efficacy of a shine control product.

### DETAILED DESCRIPTION OF THE INVENTION

One subject of the invention therefore consists, in a first aspect, of a method for qualitative and/or quantitative determination of at least one molecule of interest present on a solid surface, in which a weakly adhesive polysiloxane-based sorbent material, in which enrichment in molecules retained by said material is effected by dissolution or diffusion, is used.

By “molecule of interest” is meant a natural or synthetic, active or inactive molecule, the presence and/or the quantity whereof is to be determined.

By “molecule of interest present on a solid surface” is meant a molecule that is present on or excreted onto said surface, either because it is located there naturally or because it is found there because of the intervention of factors intrinsic or extrinsic to said surface, and may be detected by simple contact.

By “sorbent material” is meant a polymer material in which enrichment in molecules retained by said material is effected by dissolution or diffusion.

This type of material may be equally named “sorbent” or “absorbent”, in contrast to the term “adsorbent”.

Thus, absorption (or sorption) calls for different physicochemical mechanism from adsorption.

Absorption (or sorption), is a mechanism by which the molecule is retained by dissolution or diffusion in the material, which requires an equilibrium to be established between two phases, namely the phase in which the molecule of interest is originally located and the material.

Adsorption is a surface phenomenon by which molecules are retained on the surface of the material by means of chemical or physical forces. In this case, the materials which are used generally possess an adhesiveness which is either intrinsic or acquired through chemical modifications.

In the present description, the term “sorbent” is used in order to avoid any confusion between “absorbent” and “adsorbent”.

However, as indicated above, the term “sorbent” is to be understood as equivalent to “absorbent”, which means that both may be equally used.

By “weakly adhesive” it is meant that the value for adhesion to steel of said material, measured by peel strength, is lower than 1 N/15 mm, preferably lower than 0.5 N/15 mm, particularly lower than 0.2 N/15 mm.

Adhesion to steel may be measured by using a dynamometer of the type INDELCO CHATILLON TCD 200 (LLOYD INSTRUMENTS SAS). A sample of the sorbent material having a width of 15 mm is deposited on a stainless steel support. After deposit (without air bubbles), vertical traction is applied by means of the dynamometer with a speed of 50 mm/min. The value for adhesion to steel is the value of the traction force which is necessary to obtain complete unsticking of the sample.

The use of a sorbent material overcomes many drawbacks linked to the use of an adsorbent material for the following reasons:

the molecules diffuse into the totality of the sorbent material as a function of their affinity therefor, that affinity being governed by a distribution constant which depends on the molecular concentration required and the nature of the sorbent material;

the sorption mechanism, which is a mechanism of equilibrium between two phases, namely the solid surface and the polymer material, as a function of, on the one hand, the nature and the quantity of the molecule of interest and those of the polymer material and, on the other hand, the solubility or the affinity of said molecule in or for each of those phases, does not allow competition between a molecule of interest and other molecules: because of this, no displacement effect occurs, in contrast to what happens in the case of adsorption at the surface of an adsorbent material;

polysiloxane-based materials are inert and resistant to high temperatures. Because of this, thermal desorption of the molecules retained can be effected without risk of degrading the material and polluting the results. In the case of desorption by liquid extraction, the inert nature of the material also guarantees the non-degradation of the material and the reliability of the results.

In accordance with a preferred aspect, the polysiloxane-based material used in the method of the invention is substituted by one or more substituants chosen from (C₁-C₁₈) alkyl, phenyl, halophenyl, cyano (C₁-C₄) alkyl, amino (C₁-C₄) alkyl, trifluoro(C₁-C₄) alkyl, vinyl and hydroxy (C₁-C₄) alkyl groups

Advantageous polysiloxane-based materials are substituted by one or more substituants chosen from methyl, phenyl, chlorophenyl, trifluoropropyl and cyanopropyl. A particularly preferred material is polydimethylsiloxane (PDMS).

Said polysiloxane-based sorbent material may be crosslinked or uncrosslinked. The molecular weight of said sorbent material before crosslinking may be from about 2×10³ to about 10×10⁶.

By way of crosslinking agents there may be used those used routinely in the litrature, such as peroxides for example.

The glass transition temperature (T_{g}) of the polysiloxane-based sorbent material is preferably greater than −150° C., for example from about −150° C. to about +20° C.

According to one advantageous aspect of the invention, said sorbent material is used at a temperature higher than its glass transition temperature.

The preparation of polysiloxane-based materials is widely documented in the literature. Reference may be made, for example, to “Siloxane polymers”, S. J. Clarson and J. A. Semlyen, Eds, Polymer Science and Technology Series, Publ. PTR Prentice Hall Englewood Cliffs, N.J., USA, 1993.

According to an advantageous aspect of the method according to the invention, said polysiloxane-based sorbent material takes the form of a flexible strip having a thickness from about 10 mm to about 5 mm, for example.

The width and the length of the strip may be easily adapted as a function of the surface to be analyzed and may be from 0.5 to 10 cm, respectively, by way of purely indicative example. Strips of smaller or larger size may of course be made or used without any technical difficulty for the person skilled in the art.

According to a preferred aspect of the invention, the solid surface is a biological, animal or plant surface.

This biological surface is preferably chosen from skin and phanera.

In this case, the method according to the invention finds numerous applications in the biomedical and cosmetics fields.

The molecule of interest may be, for example, a constituent of the skin, in particular a constituent present in the stratum corneum, or a constituent endogenous to the organism that is excreted onto the skin. In particular, said molecule may be a marker for characterizing the state of the skin, for example one or more components of sebum (fatty acid, triglycerides, squalene, etc.), one or more epidermis markers (epidermal lipids, etc.), one or more components of perspiration, one or more markers of skin hydration, one or more markers of skin stress, one or more markers of skin inflammation, one or more markers of skin aging, etc.

Said molecule may also be, for example, an extrinsic molecule present on the surface of the skin following interaction of the skin and at least one environmental factor such as water, air, gases, pollution, etc., in particular one or more markers of pollution of the skin.

Said molecule of interest may be located naturally on the skin or found there because of the intervention of factors intrinsic or extrinsic to the skin.

In fact, there exists a physiological equilibrium between the molecules present in the various layers of the dermis and the epidermis resulting from phenomena of diffusion between these various layers (for example by absorption or excretion).

The method according to the invention may also be used to study the evolution of these markers as a function of numerous parameters such as age, biological cycles, the location on the body of the analysis, climate, etc.

The method of the invention will advantageously be used to measure the activity of a cosmetically or pharmacologically active agent on a biological surface, in particular on the skin or on phanera.

In fact, the molecule looked for may have been previously applied to the surface of the skin or administered orally or parenterally and excreted onto the skin. In particular, this molecule may be a cosmetically or pharmacologically active agent such as, for example, a compound of natural, biotechnological or synthetic origin having a biological activity and having an efficacy on the skin via biological sites, for example chosen from vitamins, oligo-elements, plant proteins, plant extracts, or any type of pharmacological agent having a preventive or curative activity vis-á-vis the state of the skin, for example anti-inflammatory, antiallergenic, healing, anti-free radical, antioxidant, etc.

In this case, the method according to the invention is used to relate the evolution of the markers specific to the skin, such as those mentioned above, with the activity of the active agent, and to measure its efficacy and its bio-availability, for example its penetration or nonpenetration at the cutaneous level.

One advantage of the method according to the invention is that, because of the use of the sorbent material, it enables the determination and analysis of an activity of an active agent vis-a-vis a specific molecule, directly and reproducibly, whereas the earlier methods generally enabled only an overall evaluation of this activity and/or had numerous drawbacks (problems caused by the competition of the molecules vis-a-vis fixing sites of the material used, tiresome sample preparation, etc.).

The molecule of interest may also be a perfume, for example, the presence whereof on the skin is to be determined.

There may also be cited, for example, the use of the method according to the invention for determining the presence of a drug (such as amphetamines, cannabis derivatives, cocaine, morphine, etc.) on the skin or hair.

The method according to the invention also finds numerous applications in the determination of a molecule of interest on a nonbiological surface or on a biological surface other than skin, such as a plant.

By way of nonlimiting example, there may be cited the determination of the presence or the quantity of contaminants on the surface of plants or elements of the soil; the determination of the possible presence of contaminants on electronic components or devices or the diffusion of contaminants from synthetic materials (such as bisphenol A from polycarbonate bottles); the determination of the possible presence of contaminants on domestic surfaces (wall and floor coverings).

The use of the sorbent material as defined above in these applications is a later aspect of the invention.

The invention also concerns, in a later aspect, a method for qualitative and/or quantitative determination of at least one molecule of interest present on a solid surface in which a weakly adhesive polysiloxane-based sorbent material as defined above is used, comprising the steps of:

bringing said polysiloxane-based sorbent material into contact with a solid surface, and

after removal of said sorbent material from said surface, subjecting said material enriched with the molecule of interest to at least one direct step analysis.

According to one advantageous aspect, said method comprises the steps of:

bringing said polysiloxane-based sorbent material as defined above into contact with a solid biological surface, and

after removal of said sorbent material from said surface, subjecting said material enriched with the molecule of interest to at least one desorption step followed by at least one analysis step.

The desorption step may be effected with the aid of a solvent, for example a volatile solvent such as acetone, or thermally. Such desorption techniques are described, for example, in the publications P. Sandra et al., J. Chromatogr., A, 928, 2001, 117 and V. G. Zuin et al., J. Chromatogr., A, 1091, 2005, 10.

The analysis step may be effected by at least one analysis technique chosen from gravimetric techniques, solution titration techniques, chromatographic techniques, electrochemical techniques, spectrometry techniques and imaging techniques.

According to an advantageous aspect of the method according to the invention, the desorption device, particularly the thermal desorption device, may be directly connected to analysis apparatus, for example gas chromatography apparatus, which provides a high measurement sensitivity for the analysis of volatile molecules.

The following examples are nonlimiting illustrations of the invention.

### EXAMPLE 1

### Qualitative and Quantitative Study of the Components of Sebum that Can be Volatilized at Temperature of 300° C. or Below

The objective of this study is the determination and the analysis of squalene and free fatty acids.

Sampling Method

A polydimethylsiloxane (PDMS) strip 15 mm×4 mm and 0.5 mm thick was applied to the surface of the forehead for 15 minutes.

After removal, the strip was inserted into an empty tube for thermal desorption.

Analysis Method

TDS2thermodesorption system with TDSA automatic passing system (Gerstel) coupled to a CIS4 temperature-programmable injector (Gerstel) installed on a 6890 N gas chromatograph (Agilent) itself coupled to a 5973 N mass spectrometer (Agilent)

desorption for 20 minutes at 300° C. at a flow rate of 50 ml/min

trapping of molecules in the CIS4 injector cooled to −100° C. by liquid nitrogen

FFAP type column: CP-WAX 58 (Varian) 25 m×0.25 mm×−0.20 μm

injection at 300° C. (12° C./s temperature ramp from −100° C. to 300° C.) with 1:20 split, helium gas vector

constant flow rate of 1 ml/min

temperature programming of the GC oven: 80° C. (0 min), 10° C./min, 180° C., (0 min), 3° C./min, 250° C. (20 min)

MS acquisition in scan mode, range 35-500 m/z.

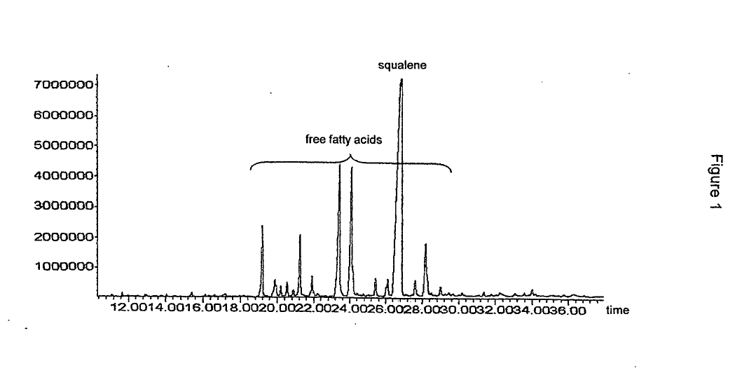

The chromatogram represented in FIG. 1 was obtained in this way.

The method of the invention thus enabled the direct analysis of the molecules sampled on the strip used for sampling by thermodesorption followed by gas chromatography and mass spectrometry.

Qualitative results (presence or absence of molecules) and quantitative results (amount of those molecules) are obtained at the same time without necessitating lengthy sample preparation.

### EXAMPLE 2

### Qualitative and Quantitative Study of All Components of Sebum

The objective of this study was the analysis of squalene, fatty acids, waxy esters and triglycerides present in sebum.

Sampling Method

A PDMS strip 15 mm×4 mm and 0.5 mm thick was applied to the surface of the forehead for 15 minutes.

After removal, the strip was extracted in 1 ml of acetone under agitation.

Analysis Method

6890 gas chromatograph (Agilent) coupled to a 5973 mass spectrometer (Agilent)

4 m×0.25 mm pre-column

column: HPl (Agilent) 10 m×0.32 mm×0.10 μm

cool-on-column injection, carrier gas: helium, constant pressure: 21 kPa

temperature programming of the GC oven: 50° C. (2 min), 10° C./min, 360° C. (5 min)

MS acquisition in scan mode, range 50-800 m/z

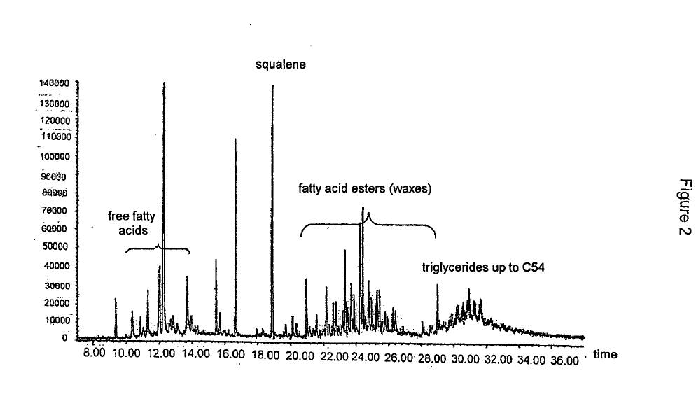

The chromatogram represented in FIG. 2 was obtained in this way.

The method of the invention therefore enabled the direct analysis of the molecules sampled on the strip used for sampling, easily extracted by a solvent.

The chromatogram obtained contained no analysis artifacts, apart from those caused by the presence of the silicone-containing material, which are easily identifiable.

### EXAMPLE 3

### Study of the Efficacy of a Shine Control Product

The object of this study was the analysis of the shine-control activity of a cosmetic product consisting of an aqueous alcoholic gel containing, at the same time, molecules active in the liberation of sebum, astringent molecules and shine-control powders with immediate effect.

The study was conducted on a panel of 25 volunteers. The efficacy of the product was evaluated over a period of 4 hours in two symmetrical areas (half-foreheads). One of the areas was used as a control (no product) and the product under test was applied to the other at the rate of 2 ml/cm² of skin. Each of the areas was divided into three sub-areas for each sampling time.

The sampling was effected at time 0 (T0) before application of the product, then at 30 minutes (T30 min) and 4 hours (T4 h) after application.

The sampling method was the same as that described for example 1.

The analysis method was similar to that described for example 1, but using a 25 m×0.25 mm×0.25 μm VF-5MS apolar column (Varian).

Results:

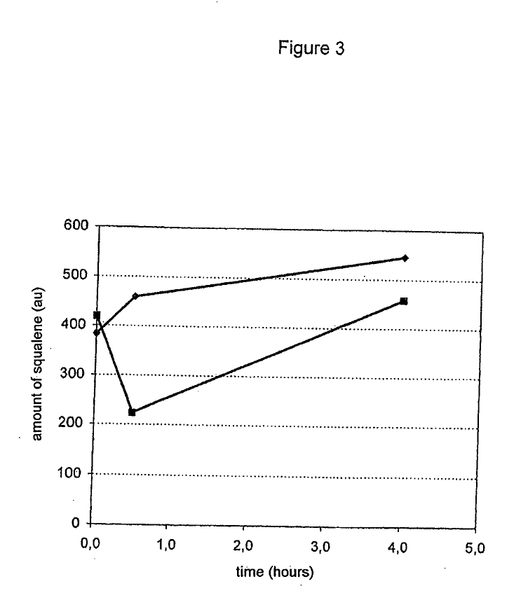

The efficacy of the product was studied by tracking the evolution of squalene, which is represented by the FIG. 3 curves, in which figure time expressed in hours is plotted on the x-axis and the amount of squalene expressed in arbitrary units (au) calculated from the area of the peaks of the chromatogram is plotted on the y-axis The symbol -♦- corresponds to the untreated area and the symbol -▪- corresponds to the treated area.

The results are based on the average of the rates for the 25 volunteers.

The results obtained were as follows:

at T0, no significant difference was observed between the treated area and the control area;

at T30 min and at T4 h a significant difference was observed between the treated area and the control area, namely a 66.4% reduction in squalene after 30 minutes and a 32.9% reduction after 4 hours for the treated area compared to the control area.

The results show that the method according to the invention enabled a specific study of one of the substances responsible for shiny skin.

1. Method for qualitative and/or quantitative determination of at least one molecule of interest present on a solid surface, comprising enriching said molecules of interest by dissolving or diffusing said molecule of interest into a weakly adhesive polysiloxane-based sorbent material, so as to retain said molecules of interest in said sorbent material.

2. Method according to claim 1, wherein the molecule of interest is desorbed from said material without degrading said material.

3. Method according to either claim 1 or claim 2, wherein said polysiloxane-based sorbent material is substituted by one or more substituants including (C₁-C₁₈)alkyl, phenyl, halophenyl, cyano(C₁-C₄)alkyl, amino(C₁-C₄)alkyl, trifluoro(C₁-C₄)alkyl, vinyl or hydroxy(C₁-C₄)alkyl groups.

4. Method according to claim 3, wherein said polysiloxane-based sorbent material is substituted by one or more substituants including methyl, phenyl, chlorophenyl, trifluoropropyl or cyanopropyl.

5. Method of claim 1, wherein said polysiloxane-based sorbent material has a molecular weight before crosslinking from about 2×10³ to about 10×10⁶.

6. Method of claims 1, wherein said polysiloxane-based sorbent material has a glass transition temperature (T_{g}) greater than −150° C.

7. Method according to claim 6, wherein said polysiloxane-based sorbent material is used at a temperature above its glass transition temperature.

8. Method of claim 1, wherein said polysiloxane-based sorbent material is polydimethylsiloxane (PDMS).

9. Method of claim 1, wherein said polysiloxane-based sorbent material is a flexible strip.

10. Method according to claim 9, wherein said strip has a thickness from about 10 μm to about 5 mm.

11. Method of claim 1, wherein the solid surface is a biological surface.

12. Method according to claim 11, wherein the solid surface is skin or phanera.

13. Method according to claim 12, wherein said molecule is a constituent of the skin or an endogenous constituent of an organism that is excreted onto the skin.

14. Method according to claim 12, wherein said molecule is one or more components of sebum, one or more epidermis markers, one or more components of perspiration, one or more markers of skin hydration, one or more markers of skin stress, one or more markers of skin inflammation, or one or more markers of skin aging.

15. Method according to claim 12, wherein said molecule was previously applied to the surface of the skin or was administered orally or parenterally and was excreted onto the skin.

16. Method according to claim 12, wherein said molecule is an extrinsic molecule present on the surface of the skin following interaction of the skin and at least one environmental factor.

17. Method of claim 1, comprising the steps of:
bringing a weakly adhesive sorbent material into contact with a solid surface, removing said sorbent material from said surface, and
after said removing, subjecting said material enriched with the molecule of interest to at least one direct analysis step.

18. Method of claim 1, comprises comprising the steps of:
bringing a weakly adhesive sorbent material into contact with a solid surface, removing said sorbent material from said surface, and
after said removing, subjecting said material enriched with the molecule of interest to at least one desorption step followed by at least one analysis step.

19. Method according to either claim 17 or claim 18, wherein said solid surface is a biological surface.

20. Method according to claim 19, wherein said solid surface is skin or phanera.

21. Method of claim 18, wherein said desorption step is effected with the aid of a solvent or thermally.

22. Method of claim 17, wherein said analysis step is effected by at least one analysis technique including gravimetric techniques, solution titration techniques, chromatographic techniques, electrochemical techniques, spectrometry techniques or imaging techniques.

23. The method of claim 1, wherein the method measures the activity of a cosmetically or pharmacologically active agent on a biological surface.

24. The method of claim 23, wherein said biological surface is skin or phanera.

25. The method of claim 1, wherein the method determines a molecule of interest on a nonbiological surface.

26. The method of claim 1, wherein the method determines a molecule of interest on a biological surface other than skin.

27. The method of claim 25 or 26 wherein said molecule to be determined is: the presence or quantity of contaminants on the surface of plants or elements of the soil, the presence or quantity of contaminants on the surface of electronic components or devices, the presence or quantity of contaminants diffusing from synthetic materials, or the presence or quantity of contaminants on domestic surfaces.

28. The method of claim 6, wherein the polysiloxane-based sorbent material has a glass transition temperature (T_{g}) from about −150° C. to about +20° C.
